(19) United States
(12) Patent Application Publication
(10) Pub. No.: US 2012/0231296 A1
(43) Pub. Date: Sep. 13, 2012

(54) METHOD FOR MANUFACTURING AN ADVANCED MAGNETIC READ SENSOR

(75) Inventors: Quang Le, San Jose, CA (US); Jui-Lung Li, San Jose, CA (US); Yongchul Ahn, San Jose, CA (US); Simon H. Liao, Fremont, CA (US); Guangli Liu, Pleasanton, CA (US); Masaya Nishioka, Kawasaki-shi (JP)

(73) Assignee: Hitachi Global Storage Technologies Netherlands B.V., AZ Amsterdam (NL)

(21) Appl. No.: 13/045,724

(22) Filed: Mar. 11, 2011

(51) Int. Cl. G11B 5/33; B44C 1/22

(52) U.S. Cl. 428/800; 216/22

(57) ABSTRACT

A method for manufacturing a magnetic sensor that minimizes topography resulting from stripe height defining masking and patterning in order to facilitate definition of track width. The method includes depositing a series of mask layers and then masking and ion milling the series of sensor layers to define a back edge of a sensor. A non-magnetic fill layer is then deposited, the magnetic fill layer being constructed of a material that has an ion mill rate that is similar to that of the series of sensor layers. A second masking and milling process is then performed to define the track width of the sensor and hard bias is deposited. Because the non-magnetic fill layer is removed at substantially the same rate as the sensor material the structure has a very flat topography on which to form the sensor track width.

### FIELD OF THE INVENTION

The present invention relates to magnetic data recording and more particularly to a method for manufacturing magnetoresistive sensor that results in improved sensor definition at very small track-widths.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor, or a Tunnel Junction Magnetoresisive (TMR) sensor can be employed to read a magnetic signal from the magnetic media. The sensor includes a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

In order to maximize data density it is necessary to minimize the track width of the magnetoresistive sensor. However, as the track width of the sensor decreases, the method used to construct the sensors face challenges that can make accurate definition of the sensor very difficult. Therefore, the remains a need for improved methods for manufacturing sensors at very small dimensions.

### SUMMARY OF THE INVENTION

The present invention provides a method for manufacturing a magnetic sensor that includes depositing a series of sensor layers and forming a first mask structure over the series of mask layers, the first mask structure having a back edge configured to define a back edge of a sensor. A first ion milling is performed to remove portions of the series of sensor layers that are not protected by the first mask structure to define a back edge of the sensor. Then, a non-magnetic fill material is deposited, the non-magnetic fill material including a material having an ion milling rate that is similar to an ion milling rate of the series of sensor layers. A second mask structure is then formed over the series of sensor layers, the second mask structure having a width configured to define a sensor width and a second ion milling is performed to remove portions of the series of sensor layers not protected by the second mask structure to define a width of the sensor.

The invention uses different dielectric materials during sensor stripe height definition processing. By using dielectric materials that have similar ion mill rates to that of the sensor material, the topography can be minimized to only a few nanometers. This almost planar surface facilitates the CMP assisted liftoff used to remove the track width defining mask structure and the fencing, allowing the mask and fencing to be completely removed without damaging the sensor material or the hard bias material. This also provides a planar hard bias formed next to the sensor track, thereby resulting in a flatter shield. In addition, the fill material must have desired breakdown voltage properties so as not to cause electrical shunting. In order to achieve this, a multi-layer fill can be used that includes a bottom layer having a high breakdown voltage, and which may also include a diffusion barrier, along with an upper layer having the desired ion mill rate.

At sensor stripe height definition processing, after the back edge of the sensor has been defined, instead of using alumina as the complete refill material, the present invention uses a refill material that is a single, bi-layer or tri-layer dielectric material having a first layer with a high breakdown voltage or which may also include diffusion barrier material and a last layer having a similar mill rate to that of the sensor material. At track-width definition processing, since the refill dielectric and the sensor material have almost the same ion mill rate at the desired ion mill angle combination, the ion milled surface will be very planar across the active region of the element and in the field. The subsequent hard bias deposition will hence result in an almost planar surface, and this near planar surface will improve its hard bias magnetic field to the sensor with a reduced asymmetrical effect.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG.-1 is a schematic illustration of a disk drive system in which the invention might be embodied;

FIG. 2 is an ABS view of a slider illustrating the location of a magnetic head thereon;

FIG. 3 is an ABS view of an example of a magnetoresistive sensor that might be constructed by a method of the present invention;

FIG. 4 is a top down view of the sensor of FIG. 3;

FIGS. 5-19 are views of a magnetic sensor in various intermediate stages of manufacture, illustrating a prior art method for manufacturing a magnetic sensor;

FIG. 20 is a cross sectional view as taken from line 20-20 of FIG. 19 illustrating a cross section of a back portion of a hard bias structure of a magnetic sensor constructed according to a method of the present invention;

FIG. 21 is a cross sectional view similar to that of FIG. 20 of a magnetic sensor constructed according to a prior art method;

FIG. 22 is a cross sectional view as taken from line 22-22 of FIG. 19 of a back edge of a sensor constructed according to an embodiment of the invention;

FIG. 23 is a cross sectional view similar to that of FIG. 22 of a magnetic sensor constructed according to a prior art method; and

FIGS. 24-27 illustrate a method for manufacturing a magnetic sensor according to an alternate embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk. 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

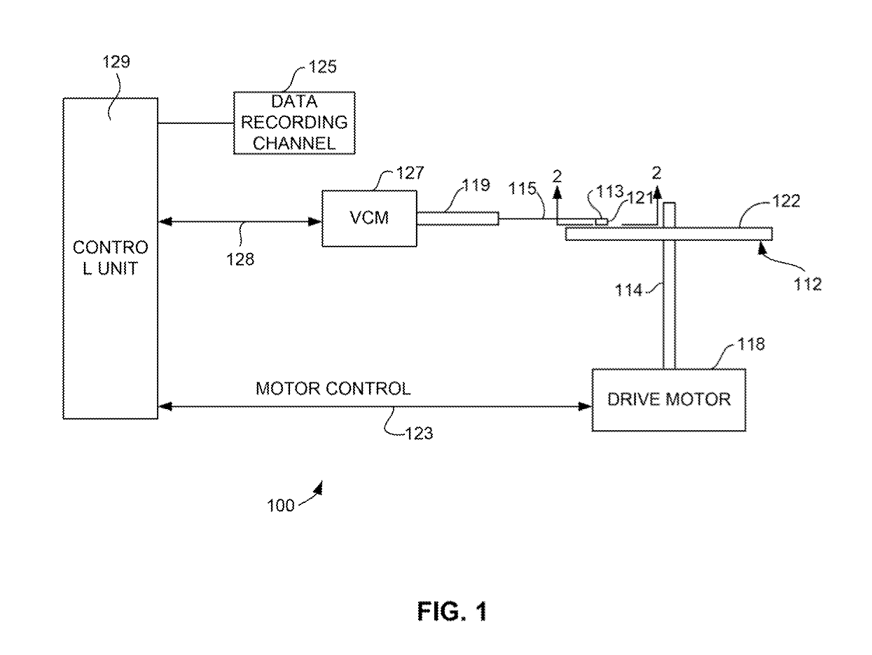

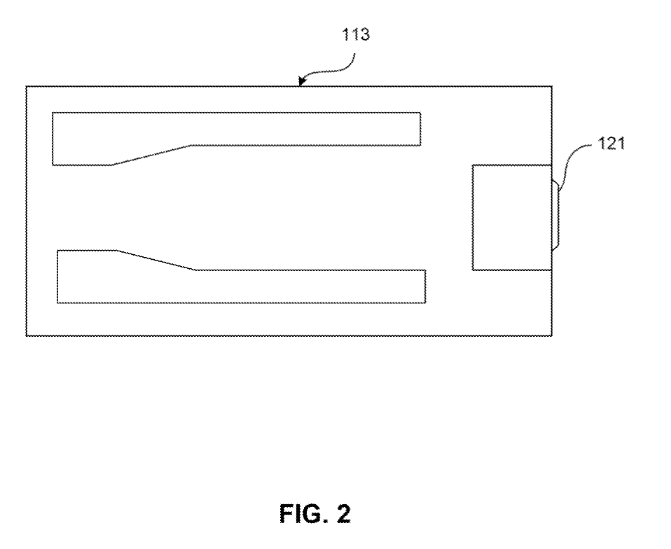

With reference to FIG. 2, the orientation of the magnetic head 121 in a slider 1.1.3 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

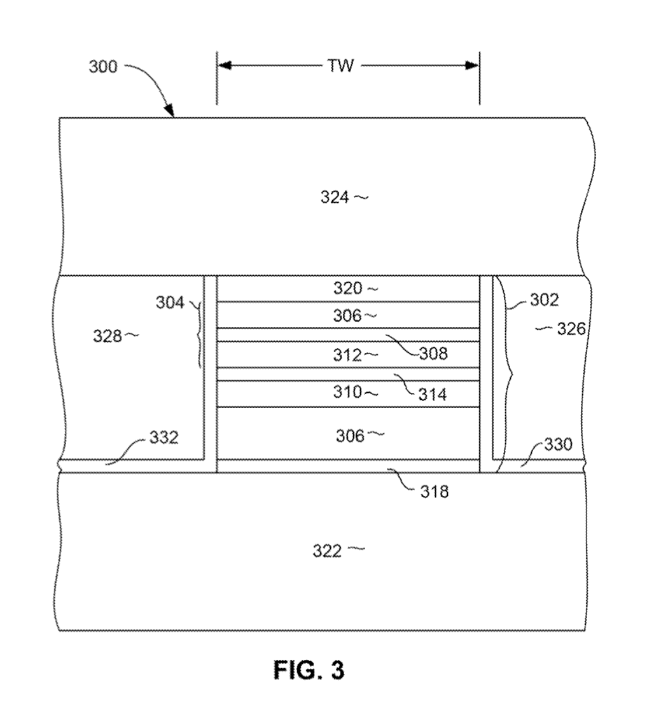

FIG. 3 shows an example of a magnetoresistive sensor structure 300 that can be constructed according to a method of the present invention. The sensor structure 300 is seen as viewed from the air bearing surface (ABS). The sensor structure includes a sensor stack 302 which can be a magnetoresistive sensor stack such as a tunnel junction magnetoresistive sensor (TMR) or a giant magnetoresistive sensor (GMR).

The sensor stack 302 includes a pinned layer structure 304, a free layer structure 306 and a non-magnetic layer 308 sandwiched between the pinned layer structure 304 and the free layer structure 306. If the sensor 300 is a TMR sensor, then the non-magnetic layer 308 is a thin, non-magnetic, electrically insulating barrier layer. If, on the other hand, the sensor 300 is a GMR sensor, then the layer 308 is a non-magnetic, electrically conductive spacer layer.

The pinned layer structure 308 can be an antiparallel coupled structure that includes first and second magnetic layers 310, 312 separated by a non-magnetic antiparallel coupling layer such as Ru 314. The magnetization of the first magnetic layer 310 is pinned in a direction perpendicular to the air bearing surface by exchange coupling with a layer of antiferromagnetic material 316. A seed layer 318 may be provided at the bottom of the sensor stack 302 in order to initiate a desired grain structure in the above layers, and a capping layer 320 can be provided at the top of the sensor stack 302 to protect the layers of the sensor stack 302 during manufacture. The sensor stack 302 is sandwiched between first and second magnetic shields 322, 324 that are constructed of an electrically conductive magnetic material so that they function as electrical leads as well as magnetic shields.

The free layer 306 has a magnetization that is biased in a direction parallel with the air bearing surface by magneto-static coupling with first and second hard magnetic bias layers 326, 328. The hard bias layers 326, 328 are separated from the sensor stack 302 and from at least one of the lead/shields 322 by thin electrically insulating layers 330, 332, which can be constructed of alumina.

During operation, a sensor current flows through the sensor stack 302 in a direction perpendicular to the planes of the layers of the sensors stack 302, the sense current being provided by the lead/shields 322, 324. The electron spin dependent tunneling of electrons through the barrier layer 308 is affected by the relative orientations of the magnetizations of the free layer 306 and layer 312. The closer these layers 306, 312 are to being parallel, the lower the electrical resistance across the barrier layer 308 will be. Conversely the closer the magnetizations of the layers 306, 312 are to being anti-parallel, the higher the electrical resistance across the barrier layer 308 will be. This change in electrical resistance can then be read as a signal in response to an external magnetic field. As seen in FIG. 3, the width of the sensor stack 302 defines a track width (TW) of the sensor. In order to maximize data density, it is desirable to minimize the track width TW as much as possible.

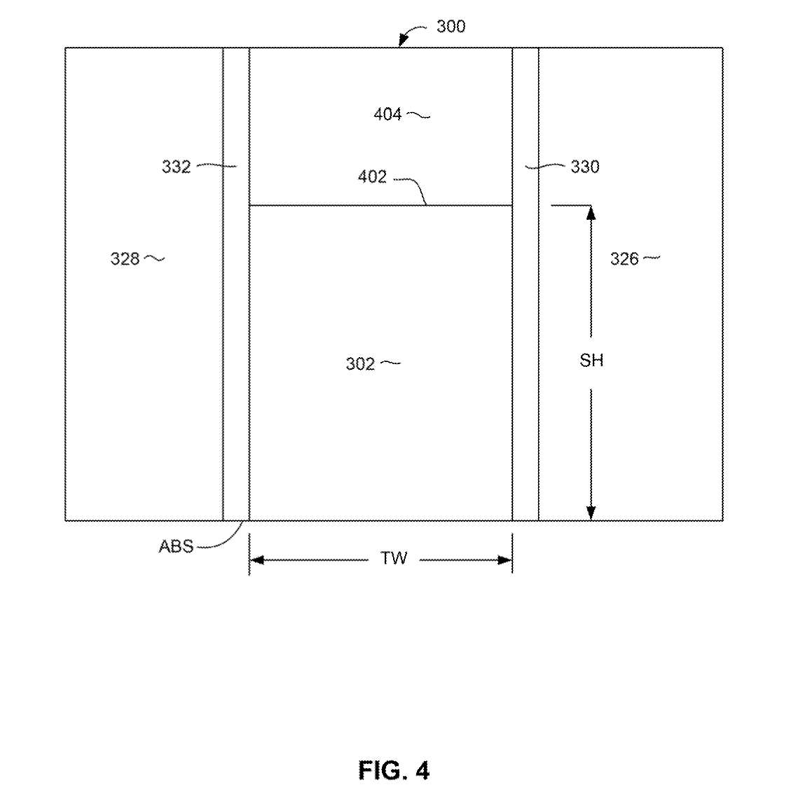

FIG. 4 shows a top down view of the sensor 300 (with the upper shield/lead 324 removed). As can be seen in FIG. 4, the sensor stack 302 has a back edge 402 that is opposite the air bearing surface (ABS). The distance between the ABS and the back edge 402 defines a stripe height (SH) of the sensor 302. The space behind the back edge 402 of the sensor stack 302 is filled with a non-magnetic insulation material 404. The material 404 can be a material such as TaOₓ for single layer. The use of a material such as TaOₓ, SiNₓ, SiOₓ, SiOₓNy, TiOₓ or MgO as a fill material for single, bi-layer, and tri-layer dielectric materials, and the advantages associated therewith will be described in greater detail herein below.

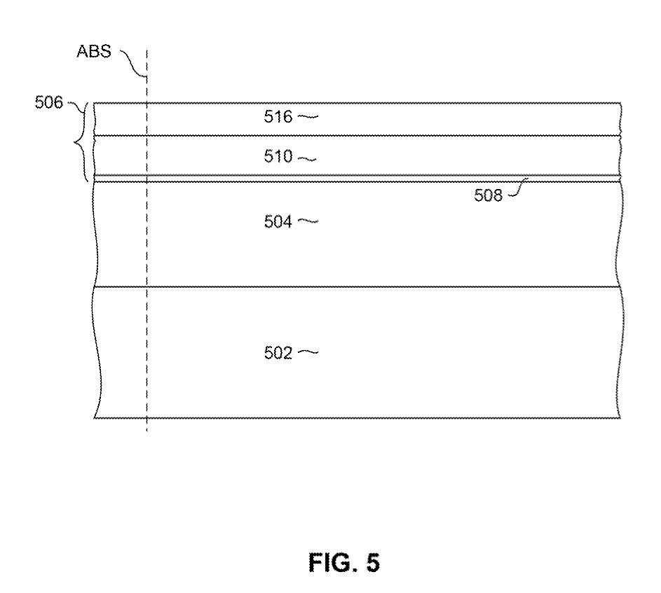

FIGS. 5-20 and 22 illustrate a method for manufacturing a magnetic read head according to an embodiment of the invention. With particular reference to FIG. 5, a bottom shield/lead 502 is formed of an electrically conductive, magnetic material such as NiFe. A plurality of sensor layers 504 are deposited over the first bottom shield 502. The sensor layers 502 can include the layers 318, 316, 304, 308, 306, 320 described above with reference to FIG. 3. However, this is by way of example only, as other sensor stack configurations could be used. A first series of mask layers 506 is then deposited over the sensor layers 504. The mask layers 506 can include a hard mask layer 508 that is constructed of a material such as diamond like carbon (DLC) that is resistant to chemical mechanical polishing. An image transfer layer 510, constructed of a soluble polyimide material such as DURIMIDE® can be deposited over the first hard mask layer 408. Finally, an image layer such as photoresist 516 is deposited at the top of the mask structure 506.

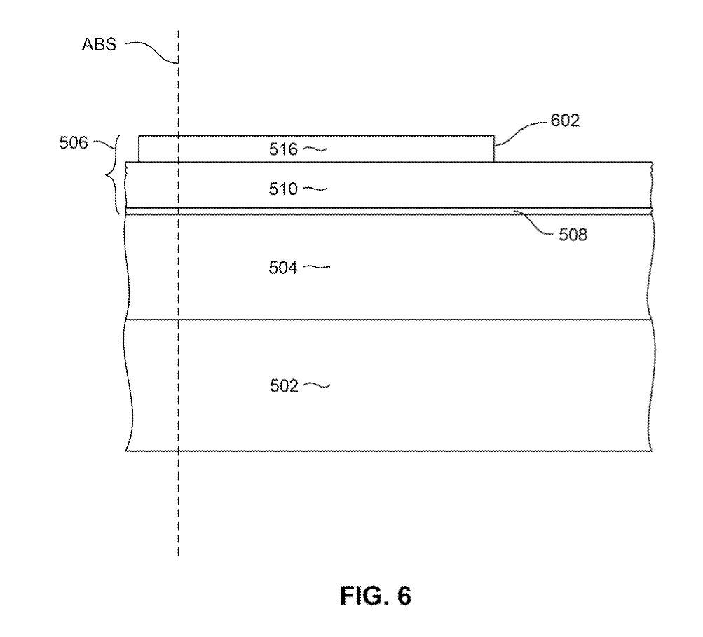

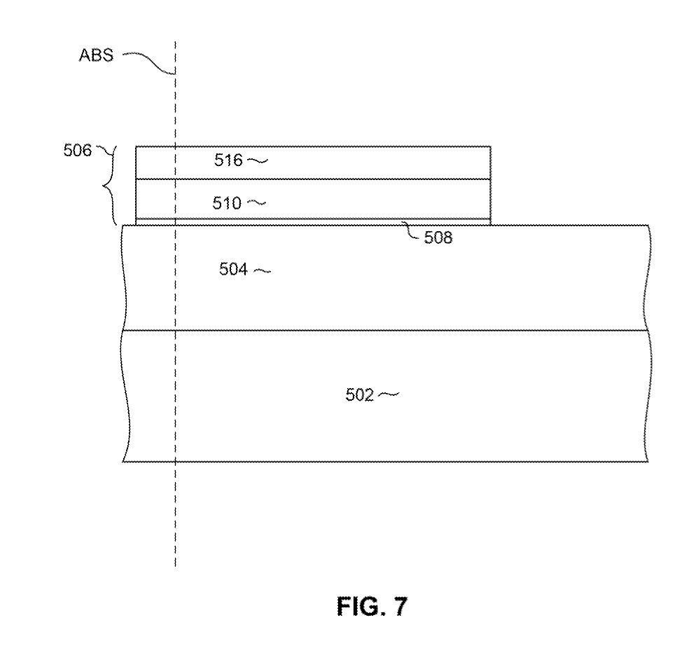

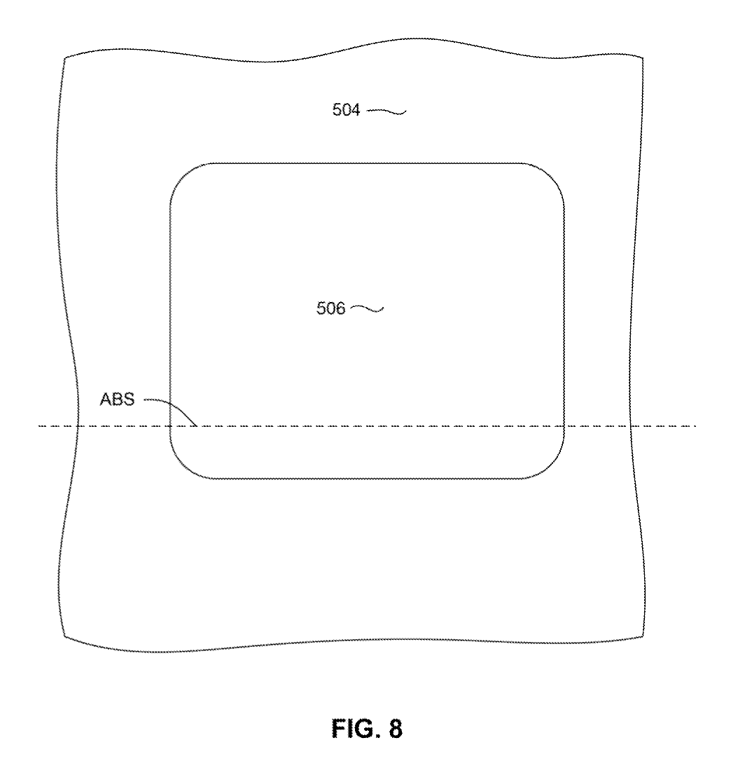

FIG. 5 shows a view of a cross section that is perpendicular to the air bearing surface. The dashed line designated “ABS” indicates the location of the air bearing surface plane. With reference now to FIG. 6, the photoresist layer is photolithographically patterned and developed to define a mask 516 as shown in FIG. 6, having a back edge 602 that will define a stripe height of the sensor (as will be seen). A reactive ion etching (RIE) can then be performed to transfer the image of the resist mask 516 onto the underlying layers 508, 510 leaving a structure as shown in FIG. 7. FIG. 8 shows a top down view of the structure of FIG. 7.

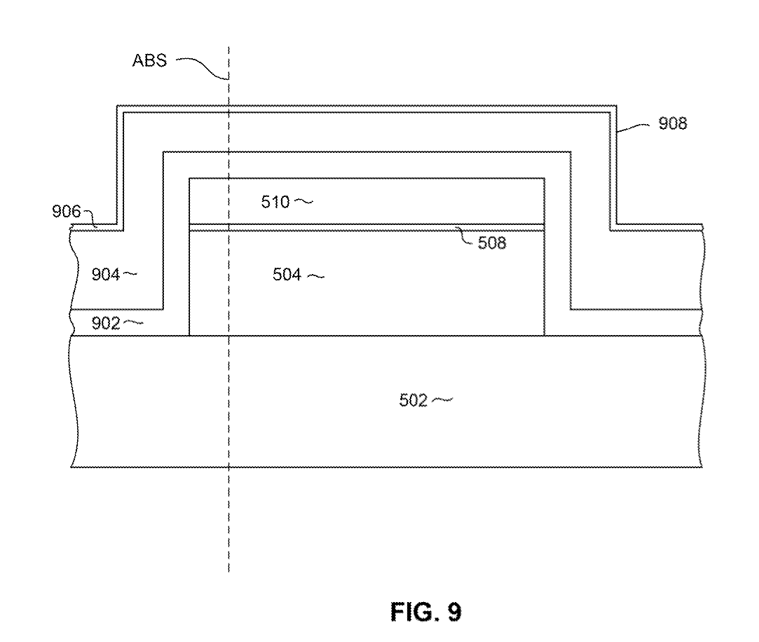

An ion milling can then be performed to remove portions of the sensor stack 504 that are not protected by the mask structure 506 leaving as sensor stack 504 as shown in FIG. 9. While the ion milling consumes a portion of the mask structure 506, a portion of the mask (e.g. layers 508, 510) remains after the ion milling.

With continued reference to FIG. 9, a relatively thin layer of a dielectric material having a high breakdown voltage (e.g. IMV/cm-8 MV/cm) such as alumina or which may also include diffusion barrier material such as SiNₓ, SiOₓN_{y}, or MgO, 902 is deposited as a first fill layer. A non-magnetic, electrically insulating second fill layer 904 is then deposited. The layer 904 is a material that is chosen to have a similar ion milling rate to that of the sensor stack 504, for reasons that will become apparent below. A layer of material that is resistant to chemical mechanical polishing (CMP stop layer) 906 is then deposited over the layers 902, 904.

As mentioned above, the fill layer 904 is chosen to have an ion mill rate that is similar to the ion mill rate of the sensor stack 504. Preferably, the fill layer 904 has a mill rate that is no more than plus or minus 5% that of the sensor stack 504. With this in mind, the fill layer 504 can be TaOₓ, but could also be SiNₓ, TiOx, SiNₓO_{y}, SiOₓ or MgO. The fill layer 904 could also be AlOₓ where X is chosen to make the AlOₓ have the desired ion mill rate discussed. In addition, the fill layer can be TaOₓ or SiOₓN_{y} single layer (902, 904) for CPP sensor.

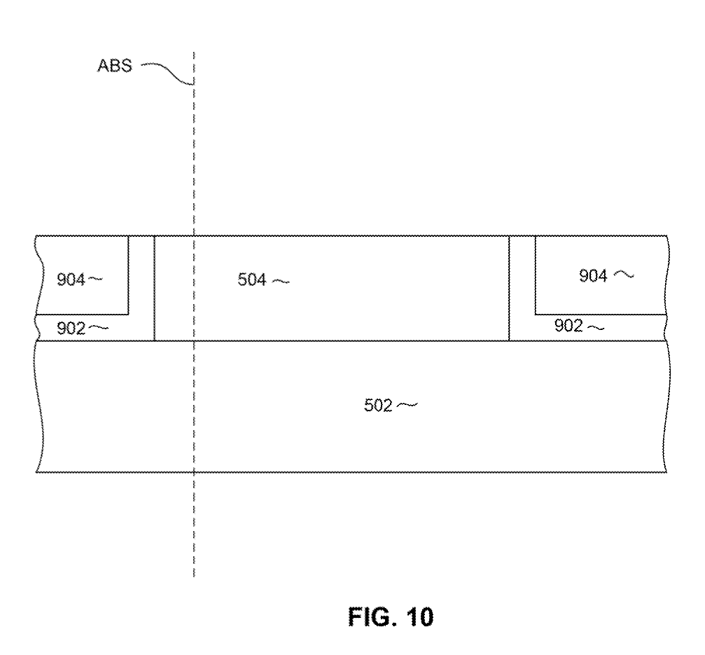

A second CMP stop layer 906 is then deposited. Like the CMP stop layer 508, the CMP stop layer 906 is a material that is resistant to chemical mechanical polishing, such as diamond like carbon (DLC). After deposition of the CMP stop layer 906, a chemical mechanical polishing process is then performed to planarize the surface of the layers 904, 902, 510. The CMP removes the bump 908 formed over the sensor stack 504, stopping at the base level of the CMP stop layer 906. The layers 902, 904, 906 are preferably deposited such that the base level of the CMP stop layer 906 is at the same level as the layer 508, which also acts as a CMP stop layer. After the chemical mechanical polishing has been performed, a quick reactive ion etching (RIE) can be performed to remove the remaining portion of layers 906, 508, and second DLC CMP stop layer, leaving a planarized structure such as shown in FIG. 10

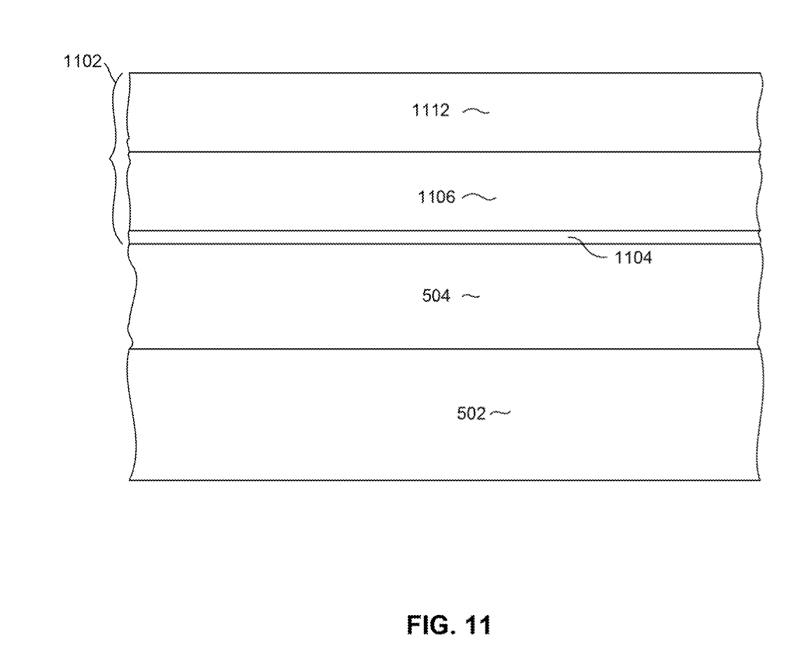

With reference now to FIG. 11, a second series of mask layers 1102 is deposited. Whereas the previously formed mask 506 (FIG. 7) was a stripe height defining mask, mask structure 1102 will be a track width defining structure as will be seen. The series of mask layers 1102 can include: a hard mask layer 1104 constructed of a CMP resistant material such as diamond like carbon (DLC); an image transfer layer 1.106 constructed of a soluble polyimide material such as DURIMIDE 0; and a layer of photoresist 1112.

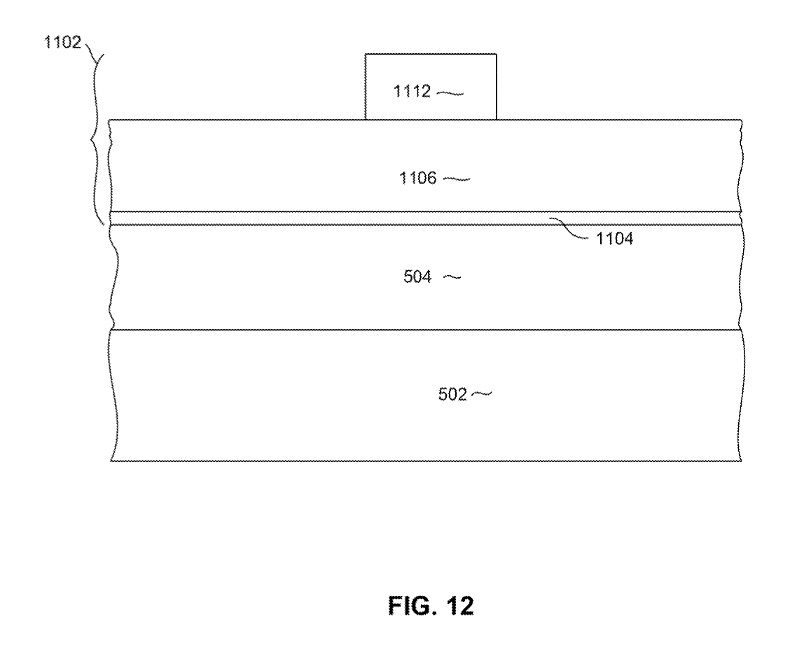

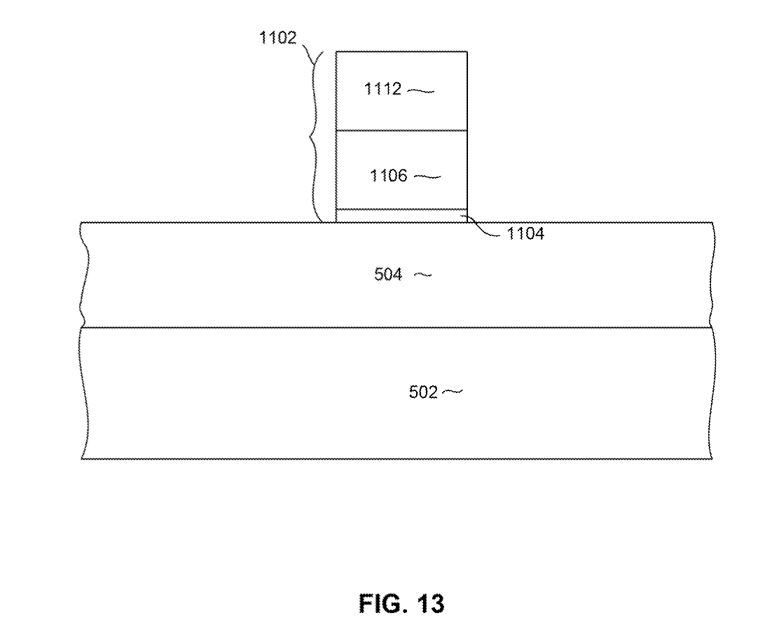

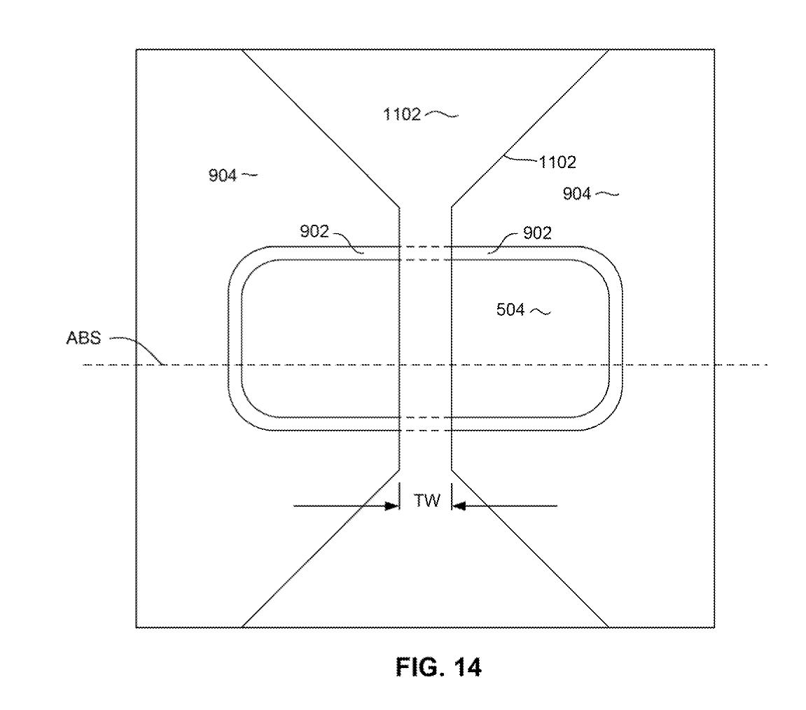

With reference to FIG. 12, the photoresist layer 1112 is photolithographically patterned and developed to form a track-width defining mask. A reactive ion etching (RIE) is then performed to transfer the image of the photoresist layer 1112 onto the underlying layers 1104, 1106, leaving a structure as shown in FIG. 13. FIG. 14 shows a top down view of the structure shown in FIG. 13. FIG. 14 shows the mask 1102 having a portion over the sensor stack 504 that defines a track width (TW).

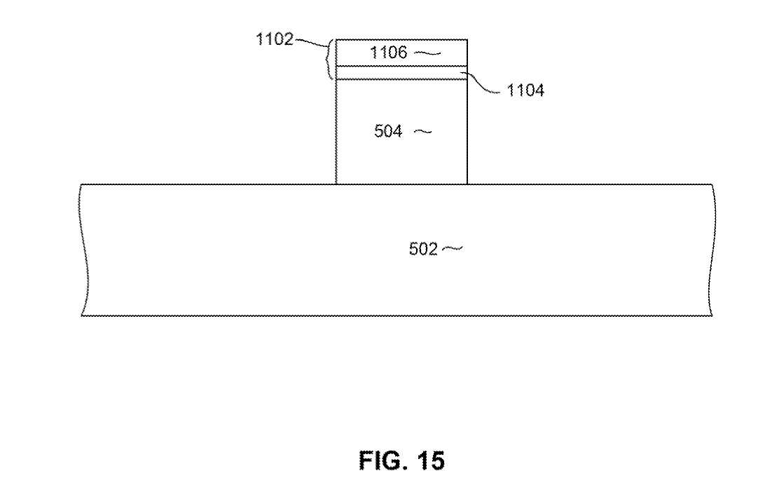

An ion milling is then performed to remove portions of the sensor stack 504 that are not protected by the mask 1102, leaving a structure as shown in FIG. 15. FIG. 15 shows a cross section along a plane that is parallel with the air bearing surface.

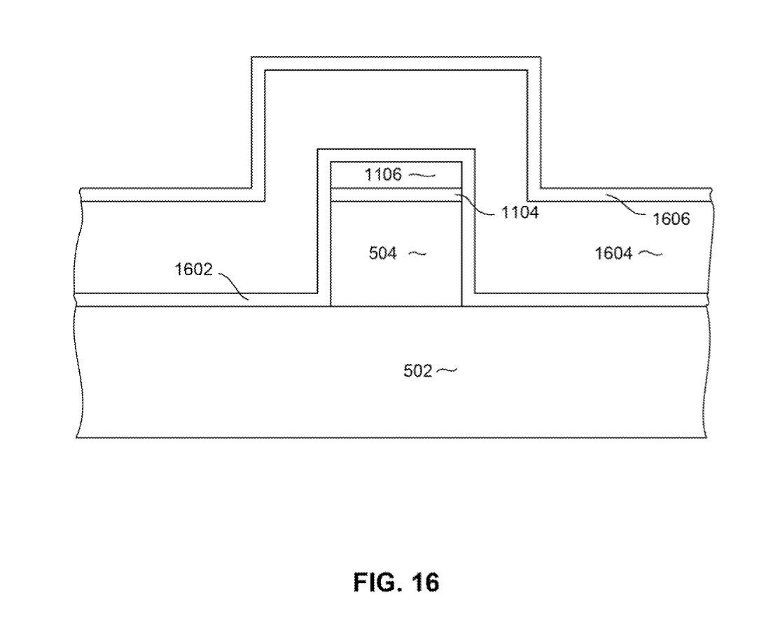

With reference now to FIG. 16, a thin layer of non-magnetic material having a high breakdown voltage, and which may also include a diffusion barrier 1602 is deposited. The layer 1602 is preferably deposited by a conformal deposition process such as atomic layer deposition (ALD) such as ALD alumina or ion beam deposition (IBD) such as SiₓN_{y}, SiOₓN_{y}, or MgO, respectively. A layer of hard magnetic material 1604 is then deposited to provide a hard bias layer. A layer of material 1606 that is resistant to chemical mechanical polishing (second CMP stop layer 1606) is then deposited. This layer is preferably diamond like carbon (DLC) and the layers 1602, 1604, 1606 are preferably deposited such that the portions of layer 1606 that are away from the sensor stack 504 are at about the same level as the hard mask layer 1104.

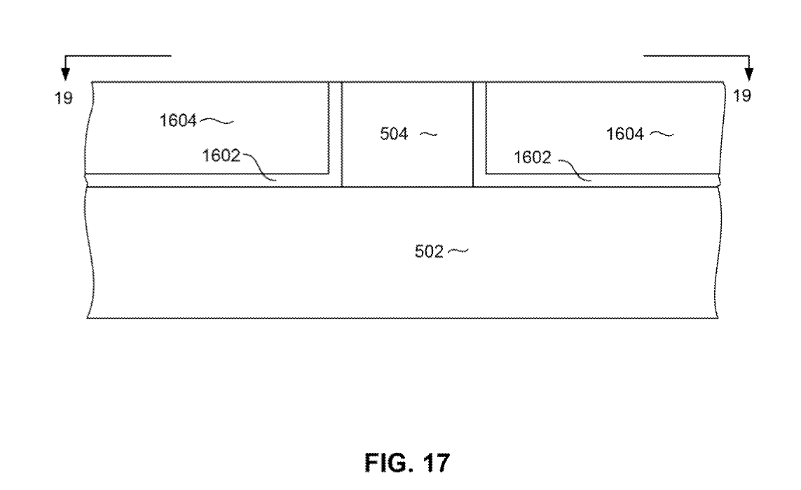

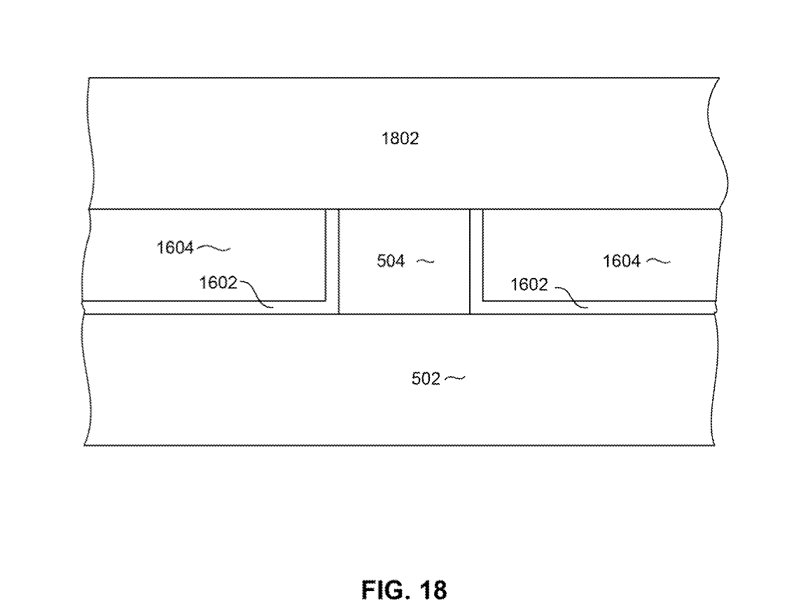

A second chemical mechanical polishing (CMP) is then performed followed by a quick reactive ion etching to remove the remaining CMP stop layer 1606 and hard mask 1104, leaving a structure such as that shown in FIG. 17. A second, or upper, magnetic shield/lead 1802 can then be formed as shown in FIG. 18. The shield/lead 1802 can be formed by an electroplating process that can include: depositing a seed layer; forming a mask; electroplating a magnetic material such as NiFe; removing the mask; and removing extraneous portions of the seed layer.

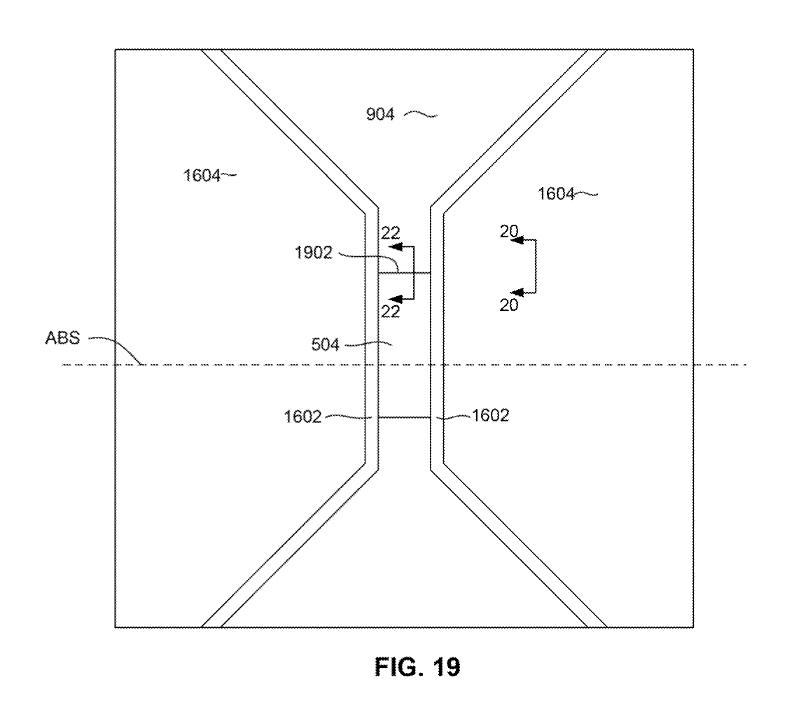

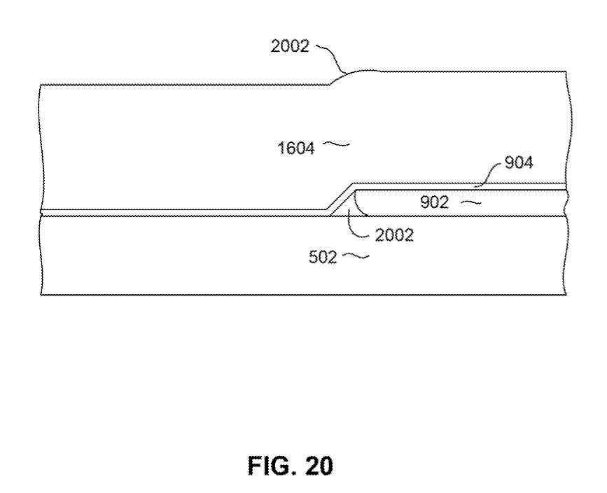

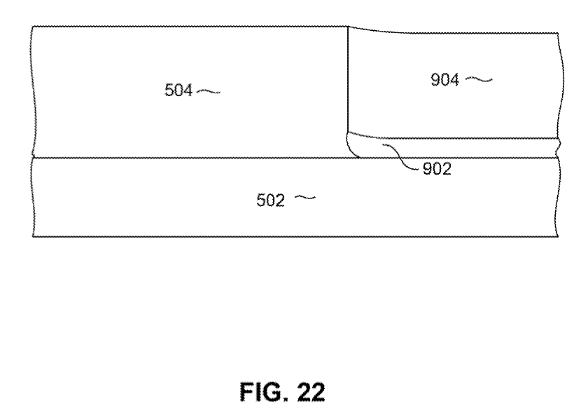

FIG. 19 is a top down view of the structure shown in FIG. 17. In FIG. 19, the location of the air bearing surface plane is indicated by the dashed line denoted ABS. As can be seen, the sensor 504 has a back edge 1902 that was formed by the above described processing steps. Line 22-22 in FIG. 19 shows the location of a cross section taken at the back edge 1902 of the sensor stack 504. This cross section 22-22 is shown in FIG. 22. Similarly, line 20-20 shows the location of a cross section taken at the same distance from the ABS plane but in the hard bias region, removed from the sensor stack 504. This cross section 20-20 is shown in FIG. 20.

With reference now to FIG. 20, it can be seen that the method described above provides a structure with a much smoother topography. FIG. 20 shows a cross section taken at the same distance from the ABS as the back edge of the sensor 504 (FIG. 19) but in the region of the hard bias layers 1604. During formation of the back edge of the sensor stack, as described above with reference to FIG. 9, a small tail of sensor material 2002 remains in regions removed from the sensor stack 504 (FIG. 19). The relatively thin layer of alumina 902 (described above with reference to FIG. 10) remains behind the location corresponding to the back edge of the sensor stack (e.g. behind the sensor tail 2002). The non-magnetic fill layer 904, which was constructed of a material that is milled at the same rate as the sensor material is very thin behind the sensor tail 2002. This means that the top of the hard bias structure 1604 has a very flat topography with only a small bump 2002, or no bump at all forming at the location corresponding with the back edge of the sensor stack (e.g. the location of the tail 2002).

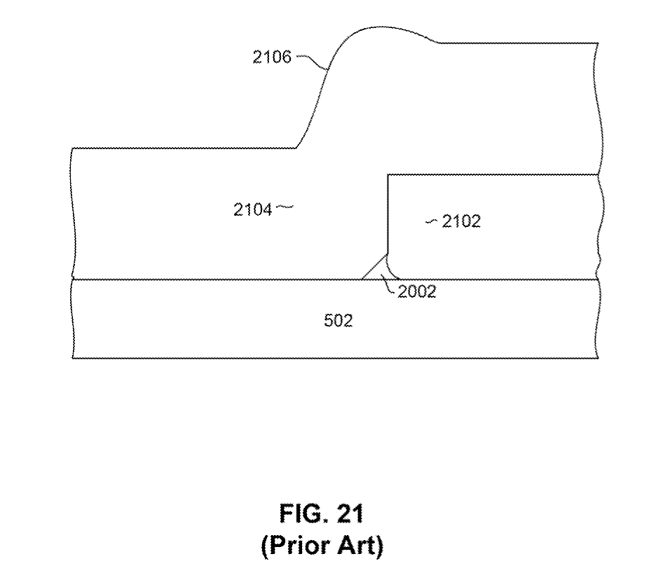

By contrast, FIG. 21 shows a cross section at a similar location of a sensor structure manufactured according to a prior art process. In this structure a fill layer 2102 such as alumina was used to fill the space behind and around the sensor stack after the first ion milling was performed to define the stripe height of the sensor. This fill 2102 does not have a mill rate that is similar to that of the sensor material. Therefore, a large amount of this fill layer material 2102 remains after ion milling. This results in a very extreme topography at the top of the hard bias material 2104 and a very large bump 2106 at the location corresponding to the back edge of the sensor (e.g. the location of the sensor tail 2002).

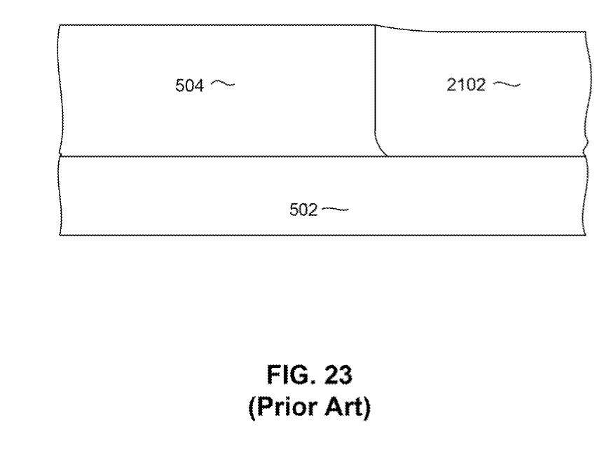

FIG. 22 shows a cross section taken at the location of the back edge of the sensor, from line 22-22 of FIG. 19. As seen in FIG. 22, a sensor constructed according to the method of the present invention, includes a thin layer of alumina 902 behind the sensor 504 and the fill layer 904 over the alumina layer 902, the fill layer 904 being constructed of a material that can has the same mill rate as the materials of the sensor 504. FIG. 23, on the other hand shows a similar cross section for a sensor constructed according to a prior art method. As can be seen in FIG. 23, the area behind the sensor stack 504 is completely filled with alumina, rather than including the novel fill layer 904.

As can be seen, the prior art method causes significant topography after the patterning and milling operation has been performed to define the back edge of the sensor. This makes it very difficult to subsequently pattern and mill the track width of the sensor. This presents a problem, because accurate definition of the track width is critically important to sensor performance. The method of the present invention, as described above with reference to FIGS. 5-19 and also with regard to FIGS. 20 and 22, solves this problem by using a fill material that can be milled at the same rate as the sensor stack so that there is little or no topography after the stripe height defining patterning and milling operation. What's more, this process adds little or no additional expense or complexity to the process for manufacturing the sensor.

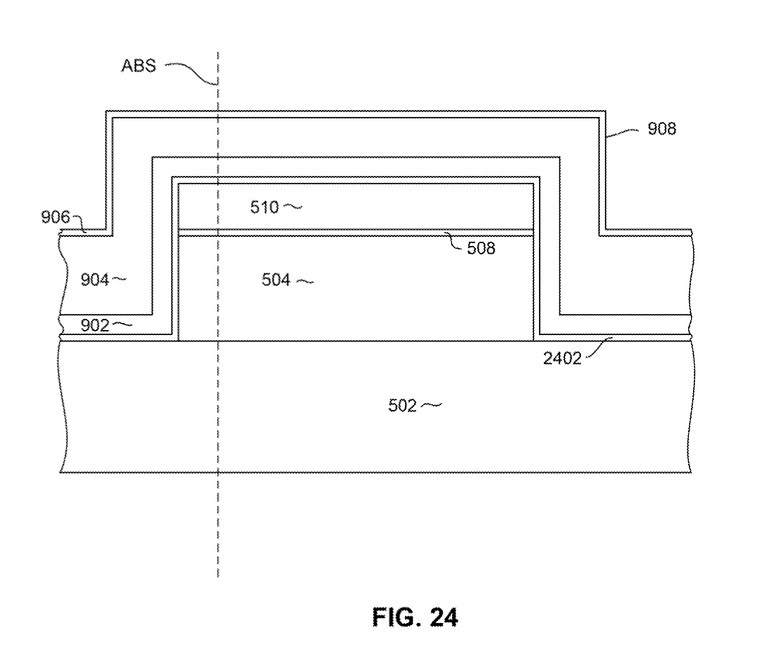

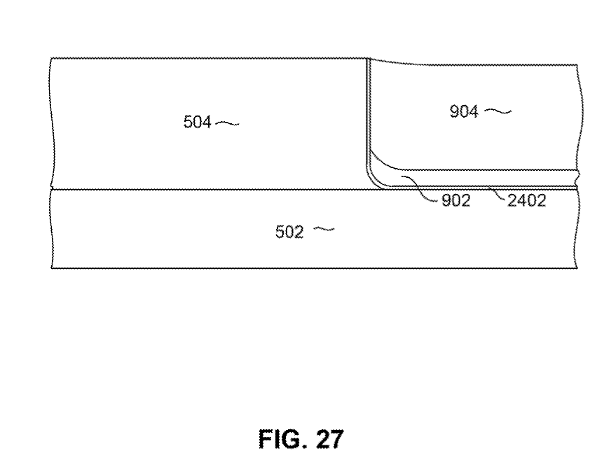

FIGS. 24-27 illustrate a method for manufacturing a magnetic sensor according to an another embodiment of the invention. FIG. 24 shows a view similar to that of FIG. 9 showing a sensor stack 504 formed by a method similar to that described above with reference to FIGS. 5-9. In FIG. 24, a tri-layer fill structure is deposited that includes a first layer 2402, a second layer 902, and a third layer 904. As in FIG. 9, a CMP stop layer 906 is preferably deposited over the fill layers 2402, 902, 904. The first layer 2402 is a relatively thin layer of a material that can act as an oxygen diffusion barrier to prevent oxygen diffusion into the sensor 504. To this end, the layer 2402 can be a first layer of SiNₓ, SiOₓN_{y} or MgO. This layer 2402 is preferably deposited just thick enough to prevent oxygen diffusion, but is thin enough to have a negligible effect on the thickness of the fill layer structure in the subsequently removed hard bias areas behind the stripe height depth, as discussed above, and as will be described further herein below. The second layer 902 of the tri-layer fill structure can be alumina (Al₂O₃) as described above. This layer 902 ensures electrical isolation in areas behind the sensor and in the field regions (away from the sensor stack). The third layer 904 is a sacrificial layer that is chosen to have a similar ion mill rate to the materials of the sensor stack 504 (as described above) and to this end can be constructed as a second layer of SiN, TaOₓ, TiO₂, SiOₓN_{y}, MgO, SiOₓ, or AlO doped as described above that is significantly thicker than the first layer 2402.

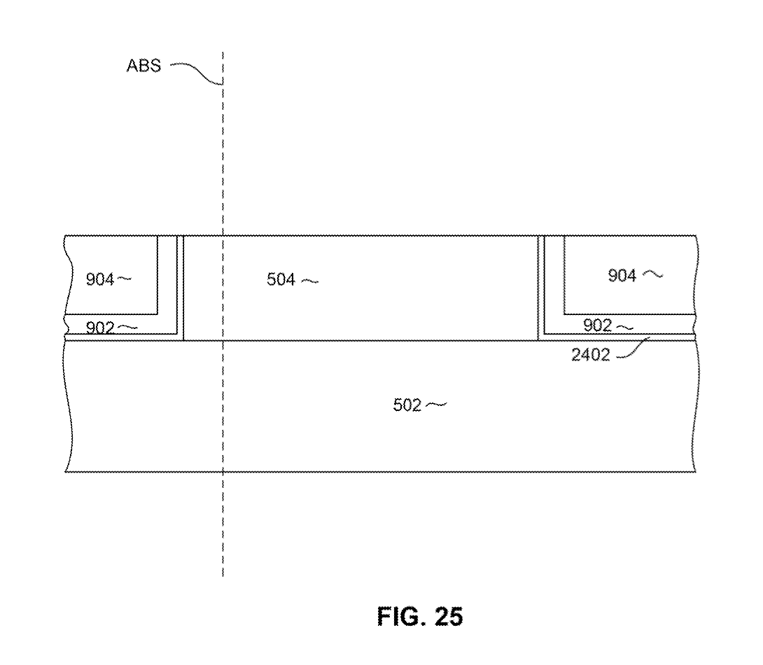

After the DLC CMP stop layer 908 is deposited, this structure is then planarized, such as by chemical mechanical polishing, as described above with reference to FIG. 10, resulting in a structure as shown in FIG. 25. Further processing steps as described above with reference to FIGS. 11-18 above can then be performed to define the track width of the sensor 504, to form hard bias structure 1604 and side insulation layers 1602 and then to form an upper shield 1802 (FIG. 18).

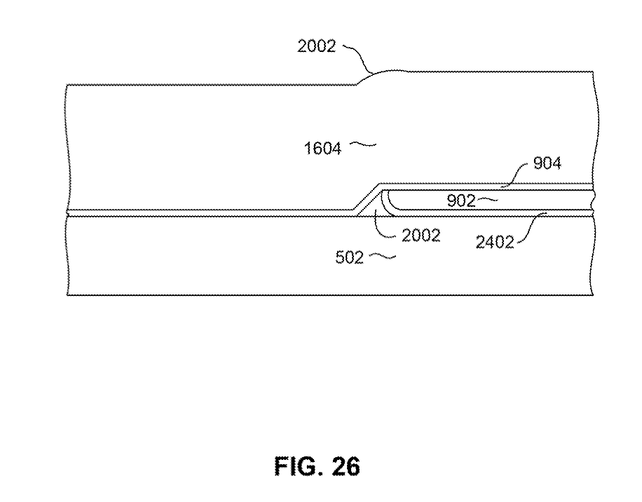

FIG. 26 is a view similar to that of FIG. 20, showing a cross section in the hard bias region, as taken from line 20-20 of FIG. 19. As can be seen, the structure includes the thin oxygen diffusion barrier layer 2402 beneath the electrically insulating fill layer 902. As can be seen, it is desirable to keep the layer 2402 thin so as to minimize the size of the bump 2002.

FIG. 25, is a view similar to that of FIG. 22, showing a cross section in the region of the back edge of the sensor stack 504, as taken from the line 22-22 of FIG. 19. As can be seen, the oxygen diffusion barrier layer 22 extends up the back edge of the sensor stack 504 to prevent oxygen from diffusing into the sensor stack 504 during manufacture of the magnetic read sensor.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic sensor, comprising:
depositing a series of sensor layers;
forming a first mask structure over the series of sensor layers, the first mask structure having a back edge configured to define a sensor back edge;
performing a first ion milling to remove portions of the series of sensor layers that are not protected by the first mask structure to define a back edge of the sensor;
depositing a non-magnetic fill material, the non-magnetic fill material including a material having an ion mill rate that is similar to an ion mill rate of the series of sensor layers;
forming a second mask structure over the series of sensor layers, the second mask structure having a width configured to define a sensor width; and
performing a second ion milling to remove portions of the series of sensor layers not protected by the second mask structure to define a width of the sensor.

2. The method as in claim 1 wherein non-magnetic fill material comprises TaOₓ, SiNx or MgO or SiOₓN_{y}.

3. The method as in claim 1 wherein the non-magnetic fill material includes SiNₓ, MgO, or SiOₓN_{y} follow by a layer of alumina, and a layer of SiNₓ, TaOₓ, TiOₓ, SiOₓN_{y}, SiOx, or MgO deposited over the layer of alumina.

4. The method as in claim 1 wherein the depositing a non-magnetic fill material includes an oxygen diffusion barrier layer, a layer of alumina deposited over the oxygen diffusion barrier layer, and a layer of SiNₓ, TaOₓ, TiOₓ, SiOₓN_{y}, SiOx, MgO deposited over the layer of alumina.

5. The method as in claim 4 wherein the oxygen diffusion layer comprises SiNₓ, SiOₓN_{y}, or MgO.

6. The method as in claim 1 further comprising after depositing the non-magnetic fill material and before forming the second mask structure:
depositing a layer of material that is resistant to chemical mechanical polishing; and performing a chemical mechanical polishing.

7. The method as in claim 1 further comprising:
after depositing the non-magnetic fill material and before forming the second mask structure:
depositing a first layer of material that is resistant to chemical mechanical polishing; and
performing a first chemical mechanical polishing; and
after performing the second ion milling:
depositing a layer of electrically insulating material;
depositing a high magnetic moment material;
depositing a second layer of material that is resistant to chemical mechanical polishing; and
performing a second chemical mechanical polishing.

8. The method as in claim 1 wherein the non-magnetic fill layer includes a layer that has an ion mill rate that is no greater than plus or minus 5 percent that of the series of sensor layers.

9. The method as in claim 1 wherein the non-magnetic fill layer comprises SiNₓ, TaOₓ, SiOₓ, TiOₓ, SiOₓ or MgO.

10. The method as in claim 1 wherein the non-magnetic fill layer comprises AlOx where X is chosen so as to cause the AlOx to have an ion mill rate that is no greater than plus or minus 5% of an ion mill rate of the series of sensor layers.

11. The method as in claim 1 wherein forming a first mask structure further comprises:
depositing hard mask layer constructed of a material that is resistant to chemical mechanical polishing on the series of sensor layers;
depositing an image transfer layer on the first hard mask layer;
depositing a photoresist layer on the image transfer layer;
photolithographically patterning the photoresist layer; and
performing a reactive ion etching to transfer the image of the photoresist layer onto the image transfer layer and the hard mask.

12. A method as in claim 1 wherein the non-magnetic fill includes a dielectric layer having a high breakdown voltage and the material having an ion milling rate that similar to an ion milling rate of the series of sensor layers.

13. The method as in claim 12 wherein the material having an ion milling rate that similar to an ion milling rate of the series of sensor layers is deposited over the layer having a high dielectric constant.

14. The method as in claim 12 wherein the dielectric material has a breakdown voltage of at least 1-8 MV/cm.

15. A magnetic sensor comprising:
a sensor stack having a back edge and first and second laterally opposed sides; and
a non-magnetic fill layer extending from the back edge of the sensor stack, the non-magnetic fill layer comprising a material having an ion mill rate that is similar to that of the sensor stack.

16. The magnetic sensor as in claim 15 wherein the non-magnetic fill layer comprises a material having an ion mill rate that is not more than plus or minus 5 percent of the ion mill rate of the sensor stack.

17. The magnetic sensor as in claim 15 wherein the non-magnetic fill layer comprises a non-magnetic, dielectric material having a high breakdown voltage, which may also be an oxygen diffusion barrier layer and a non-magnetic material having an ion mill rate that is similar to an ion mill rate of the sensor stack formed over the dielectric material.

18. The magnetic sensor as in claim 17 wherein the magnetic dielectric material is an oxygen diffusion barrier.

19. The magnetic sensor as in claim 14 wherein the non-magnetic fill layer comprises SiNₓ, SiOₓN_{y}, or MgO.

20. The magnetic sensor as in claim 14 wherein the non-magnetic fill layer comprises SiN, TaO, SiOₓN_{y}, TiOₓ, SiOx or MgO.

21. The method as in claim 14 wherein the non-magnetic fill layer comprises AlOx where X is chosen so as to cause the AlOx to have an ion mill rate that is no greater than plus or minus 5% of an ion mill rate of the series of sensor layers.
